(19) United States
(12) Patent Application Publication
(10) Pub. No.: US 2018/0291989 A1
(43) Pub. Date: Oct. 11, 2018

(54) TORQUE CONVERTER

(71) Applicant: Schaeffler Technologies AG & Co. KG, Herzogenaurach (DE)

(72) Inventors: Christopher Krause, Ashland, OH (US); Carleton Caldwell, Wadsworth, OH (US); Adam Saleh, Westerville, OH (US)

(73) Assignee: Schaeffler Technologies AG & Co. KG, Herzogenaurach (DE)

(21) Appl. No.: 15/482,921

(22) Filed: Apr. 10, 2017

(51) Int. Cl. F16H 41/24

(52) U.S. Cl. CPC F16H 41/24; F16H 2041/246

(57) ABSTRACT

A torque converter including a cover for receiving torque from a prime mover, an impeller fixed to the cover to form a housing of the torque converter, a turbine disposed in the housing for receiving torque from the impeller, a stator disposed in the housing for multiplying the torque and a one-way clutch connected to the stator. A side plate is connected to the one-way clutch, the side plate having a sealing surface that is in contact with a seal that seals the side plate to a turbine hub.

### FIELD OF INVENTION

The present invention relates to a torque converter and more specifically to a torque converter with a side plate sealed to a turbine hub.

### BACKGROUND

U.S. Pat. No. 8,844,691 B2 describes a torque converter including a cover for receiving torque from a prime mover, an impeller fixed to the cover to form a housing for the torque converter, a turbine disposed in the housing for receiving torque from the impeller, and a clutch backing plate fixed to the housing and arranged to receive a force, in an axial direction, from the turbine during operation of the torque converter.

### SUMMARY

One object of the invention is to provide a torque converter comprising a cover for receiving torque from a prime mover, an impeller fixed to the cover to form a housing of the torque converter, a turbine disposed in the housing for receiving torque from the impeller, a stator disposed in the housing for multiplying the torque, a one-way clutch connected to the stator, and a side plate connected to the one-way clutch, the side plate having a sealing surface that is in contact with a seal that seals the side plate to a turbine hub. By using the side plate as sealing part and not the inner race of the one-way clutch, the one-way clutch can be manufactured easier and thus less expensive.

The one-way clutch may comprise an outer race, an inner race and rollers in between the outer race and the inner race. Other variants of clutches can be used instead, e.g. sprag or rocker one-way clutches.

In another embodiment, the side plate is directly connected to the one-way clutch.

In another embodiment the side plate comprises a first radial part that is in contact with the one-way clutch and a second axial part that is in contact with the seal and the turbine hub.

In another embodiment the side plate has an L-shape and is made of metal. Especially, the side plate is made of sheet metal and is stamped.

In another embodiment the seal is provided in a groove of the turbine hub. Thus, the seal is centered and fixed in its axial direction.

In another embodiment the seal is a non-machined seal. The seal may have a diameter bigger than the depth of the groove. Thus, when the side plate is pressed against the seal it is a fluid tight connection.

In another embodiment the second part of the side plate may be as large as the length of the seal. In this embodiment, the turbine hub doesn't have a groove for the centering of the seal.

In another embodiment the side plate has a socket for receiving the seal. This socket can center and fix the seal in its radial and axial position. The socket has a pot-shaped form. In another embodiment, the socket has a depth that is smaller than the inner diameter of the seal. Another object of the invention is to provide a torque converter comprising a cover for receiving torque from a prime mover, an impeller fixed to the cover to form a housing of the torque converter, a turbine disposed in the housing for receiving torque from the impeller, a stator assembly disposed in the housing for multiplying the torque, the stator assembly including, a one-way clutch, and a side plate for retaining the one-way clutch in the stator, the side plate having a sealing surface, and including a turbine hub, and a seal in contact with the side plate sealing surface and the turbine hub for sealing the side plate to the turbine hub.

### BRIEF DESCRIPTION OF THE DRAWINGS

The foregoing Summary and the following detailed description will be better understood when read in conjunction with the appended drawings, which illustrate embodiments of the invention. In the drawings:

FIG. 1 is a top-half cross section of a torque converter according to a first embodiment,

FIG. 2 is a partial view of a torque converter showing the side plate according to FIG. 1,

FIG. 3 is a partial view of a torque converter showing a side plate according to a second embodiment, and

FIG. 4 shows a partial view of a torque converter with a side plate according to a third embodiment.

### DETAILED DESCRIPTION OF THE PREFERRED EMBODIMENTS

Certain terminology is used in the following description for convenience only and is not limiting. The words “front,” “rear,” “upper” and “lower” designate directions in the drawings to which reference is made. The words “inwardly” and “outwardly” refer to directions toward and away from the parts referenced in the drawings. “Axially” refers to a direction along the axis of a shaft. A reference to a list of items that are cited as “at least one of a, b, or c” (where a, b, and c represent the items being listed) means any single one of the items a, b, or c, or combinations thereof. The terminology includes the words specifically noted above, derivatives thereof and words of similar import.

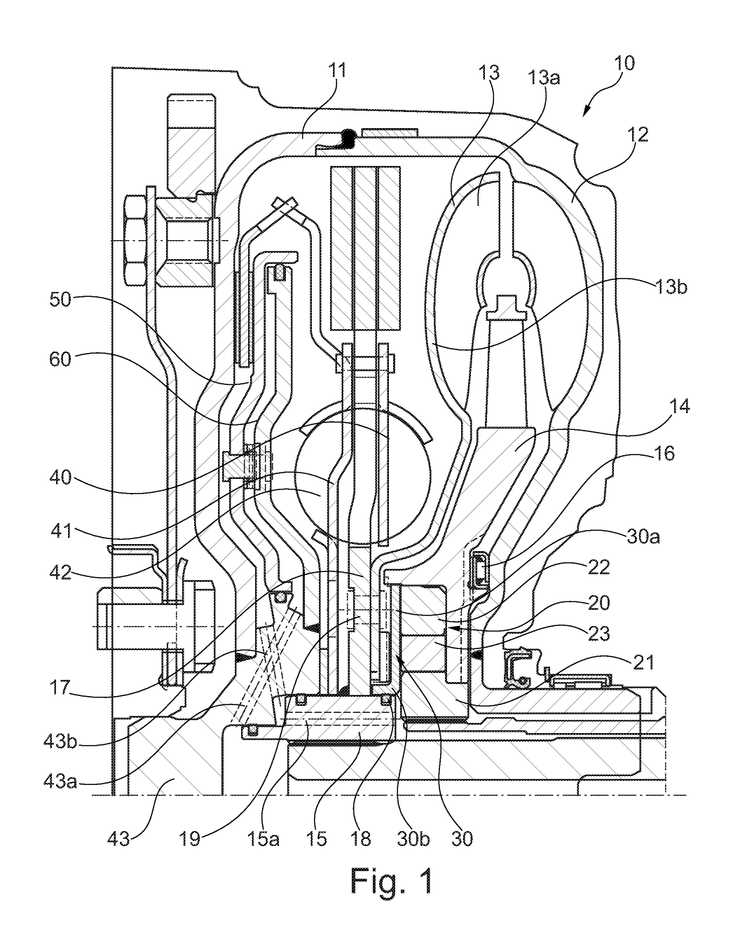

FIG. 1 shows the top-half of a torque converter in a cross sectional view. The converter 10 comprises a cover 11 that is connected to an impeller 12. The cover 11 and the impeller 12 together forming a housing. They are connected to each other by welding, for example. The torque converter 10 further comprises a turbine 13 with turbine blades 13a and a turbine shell 13b. A stator 14 is arranged between the impeller 12 and the turbine 13.

The stator 14 is connected to a one-way clutch 20 integrated into the torque converter 10. The one-way clutch 20 comprises an inner race 21, an outer race 22 and rollers 23 in between them. The outer race 22 may be press-fit into the stator 14. The stator 14 is axially positioned by a bearing 16. A side plate 30 with a first part 30a and a second part 30b is press-fitted or staked into the stator to fix the one-way clutch 20 in the stator. The second part 30b of the side plate 30 overlaps a turbine hub 15. There is a seal 18 in between the side plate 30 and the turbine hub 15. The seal 18 may be a non-machined seal. The side plate 30 may have a socket for receiving the seal 18. The turbine shell 13b is connected to a flange 17 by a rivet 19. The flange 17 is disposed between cover plates 40, 41. A spring 42 is in torque flow between the cover plates 40, 41, and flange 17. The flange 17 is drivingly engaged to an input shaft through the turbine hub 15 by welding, for example. The turbine hub 15 has a fluid channel 15a for the passage of cooling fluid.

The cover 11 of the torque converter 10 is furthermore connected to a pilot 43 that has two fluid channels 43a, 43b. The cover 11 and the pilot 43 may be welded together. The second fluid channel 43b is in fluid communication with the fluid channel 15a of the turbine hub 15 and a first fluid chamber 50. The first fluid channel 43a is in fluid communication with a second fluid chamber 60.

In torque converter mode, torque received by the cover 11 is transferred from the impeller 12 to the turbine 13, and multiplied through the stator 14. Torque from the turbine 13 is transmitted through the flange 17 to the transmission input shaft. In torque converter clutch mode, torque received by the cover 11 is transferred to the cover plates 40, 41, through spring 42 and flange 17, to the transmission input shaft.

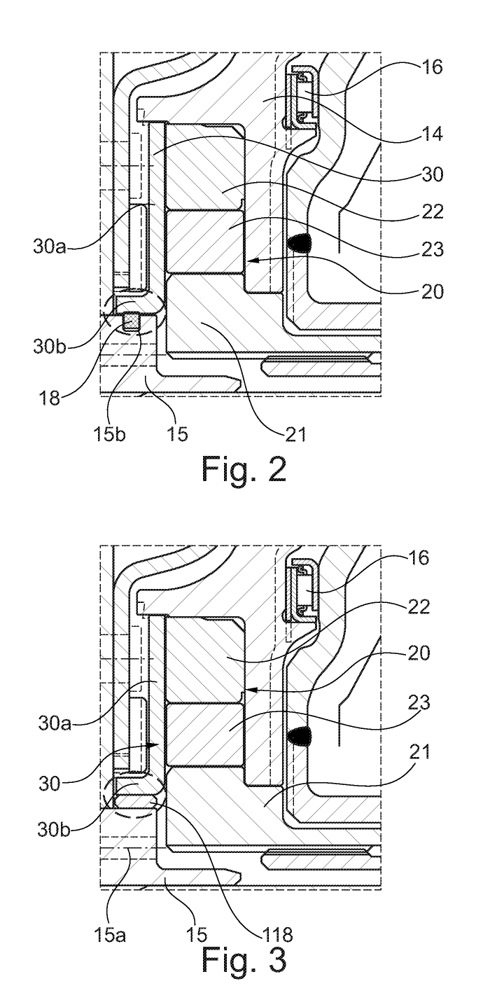

FIG. 2 shows a partial view of a torque converter showing the side plate 30 according to FIG. 1. The side plate 30 is press-fitted between or staked onto the stator 14 and the turbine hub 15. Between the second part 30b of the side plate 30 and the turbine hub 15 there is provided the seal 18. The seal 18 is assembled into a groove 15b of the turbine hub 15. The seal 18 extends beyond the outer surface of the turbine hub 15 in a radial direction in order to get pressed against the side plate 30 for a tight sealing. This means that the seal 18 has a diameter bigger than the inside diameter of the side plate 30 or the depth of the groove 15b of the turbine hub 15.

FIG. 3 shows another partial view of a torque converter according to another embodiment. The seal 118 is pressed directly into the side plate 30. Thus, the turbine hub 15 doesn't have a groove for the fixation of the seal 118 in this embodiment. The axial length of the seal 118 can be equal to the length of the second part 30b of the side plate 30. It is also possible that the axial length of the seal 118 is longer or shorter than the length of the second part 30b of the side plate 30. Seal 118 may be a bushing, for example.

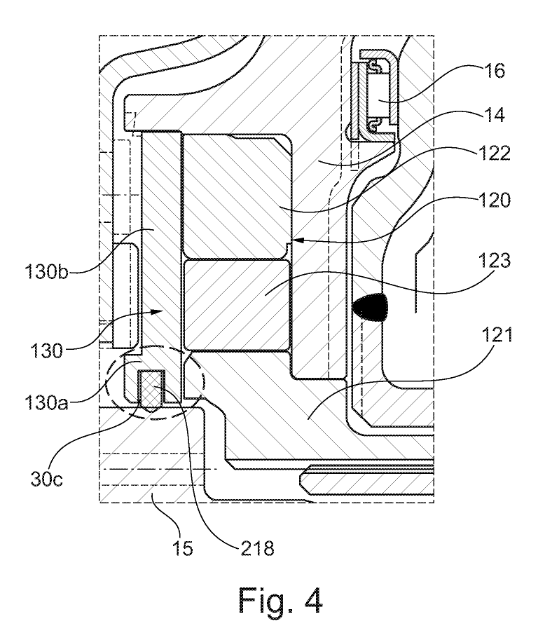

FIG. 4 shows a fourth embodiment of the sealing between the side plate 130 and the turbine hub 15. The seal 218 is disposed in a socket 30c that is provided in the first part 130a of the side plate 130. The radial length of the seal 218 is longer than the depth of the socket 30c of the side plate 130. The seal 218 extends beyond the outer surface of the socket 30c. The side plate 130 is staked to the stator 14 and the seal 218 is compressed for a tight sealing. In this embodiment, the inner race 121 of the one-way clutch 120 can overlap with the turbine hub at least partially in the radial direction.

Having thus described the present invention in detail, it is to be appreciated and will be apparent to those skilled in the art that many physical changes, only a few of which are exemplified in the detailed description of the invention, could be made without altering the inventive concepts and principles embodied therein. It is also to be appreciated that numerous embodiments incorporating only part of the preferred embodiment are possible which do not alter, with respect to those parts, the inventive concepts and principles embodied therein. The present embodiment and optional configurations are therefore to be considered in all respects as exemplary and/or illustrative and not restrictive, the scope of the invention being indicated by the appended claims rather than by the foregoing description, and all alternate embodiments and changes to this embodiment which come within the meaning and range of equivalency of said claims are therefore to be embraced therein.

### LIST OF REFERENCE NUMERALS

10 Torque converter
11 Cover
12 Impeller
13 Turbine
13a Turbine blades
13b Turbine shell
14 Stator
15 Turbine hub
15a Fluid channel
15b Groove
16 Bearing
17 Flange
18, 118, 218 Seal
19 Rivet
20, 120 One-way clutch
21, 121 Inner race
22, 122 Outer race
23, 123 Rollers
30, 130 Side plate
30a, 130a First part
30b, 130b Second part
30c Socket
40, 41 Cover plates
42 Spring
43 Pilot
43a First fluid channel
43b Second fluid channel
50 First fluid chamber
60 Second fluid chamber

What is claimed is:

1. A torque converter comprising:
a cover for receiving torque from a prime mover,
an impeller fixed to the cover to form a housing of the torque converter;
a turbine disposed in the housing for receiving torque from the impeller;
a stator disposed in the housing for multiplying the torque;
a one-way clutch connected to the stator; and
a side plate connected to the one-way clutch; the side plate having a sealing surface that is in contact with a seal that seals the side plate to a turbine hub.

2. The torque converter as recited in claim 1, wherein the one-way clutch comprises an outer race, an inner race and rollers in between the outer race and the inner race.

3. The torque converter as recited in claim 1, wherein the side plate is directly connected to the one-way clutch.

4. The torque converter as recited in claim 1, wherein the side plate comprises a first radial part that is in contact with the one-way clutch and a second axial part that is in contact with the seal and the turbine hub.

5. The torque converter as recited in claim 1, wherein the side plate has an L-shape and is made of metal.

6. The torque converter as recited in claim 1, wherein the seal is provided in a groove of the turbine hub.

7. The torque converter as recited in claim 1, wherein the seal is a non-machined seal.

8. The torque converter as recited in claim 1, wherein the seal extends beyond the outer surface of the turbine hub in a radial direction.

9. The torque converter as recited in claim 4, wherein the second part of the side plate is as large as the length of the seal.

10. The torque converter as recited in claim 1, wherein the side plate has a socket for receiving the seal.

11. The torque converter as recited in claim 10, wherein the socket is in the second part of the side plate.

12. The torque converter as recited in claim 10, wherein the seal extends beyond the outer surface of the socket.

13. A torque converter comprising:
a cover for receiving torque from a prime mover,
an impeller fixed to the cover to form a housing of the torque converter;
a turbine disposed in the housing for receiving torque from the impeller;
a stator assembly disposed in the housing for multiplying the torque, the stator assembly including:
a one-way clutch; and
a side plate for retaining the one-way clutch in the stator, the side plate having a sealing surface;
a turbine hub; and
a seal in contact with the side plate sealing surface and the turbine hub for sealing the side plate to the turbine hub.
